(19) United States
(12) Patent Application Publication
(10) Pub. No.: US 2026/0109262 A1
(43) Pub. Date: Apr. 23, 2026

(54) VEHICLE ENERGY STORAGE SYSTEMS INCLUDING BATTERY PACKS HAVING ENERGY STORAGE CHEMISTRIES

(71) Applicant: GM GLOBAL TECHNOLOGY OPERATIONS LLC, Detroit, MI (US)

(72) Inventors: Jian YAO, Shanghai (CN); Lei HAO, Shelby Township, MI (US); Yusheng ZOU, Northville, MI (US); Chengwu DUAN, Shanghai (CN); Zhenwen HU, Shanghai (CN); Mohamed KAMEL, Birmingham, MI (US)

(21) Appl. No.: 18/991,061

(22) Filed: Dec. 20, 2024

(30) Foreign Application Priority Data
Oct. 22, 2024 (CN) 2024114819591

(51) Int. Cl. B60L 58/12; B60L 53/20; B60L 58/27; H02J 7/00; H02J 7/34

(52) U.S. Cl. CPC B60L 58/12; B60L 53/20; B60L 58/27; H02J 7/342; H02J 7/50; B60L 2210/10; B60L 2240/526; B60L 2240/545

(57) ABSTRACT

An example energy storage system for an electric vehicle includes a first battery pack having a first energy storage chemistry, which is electrically coupled in series with a second battery pack having a second energy storage chemistry. A charging circuit is electrically coupled with the first battery pack and the second battery pack, and includes multiple switches and a direct current (DC)-DC controller configured to obtain a current temperature of the battery packs, in response to the current temperature being below a low temperature threshold value, operate the multiple switches in an alternating current (AC) heating mode to increase a temperature of at least one of the battery packs, and in response to the current temperature being above a high temperature threshold value, operate the multiple switches in an energy movement mode to modify a state of charge (SOC) value of at least one of the battery packs.

### CROSS-REFERENCE TO RELATED APPLICATIONS

This application claims the benefit of Chinese Patent Application No. 202411481959.1, filed on Oct. 22, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle energy storage systems, and more particularly to vehicle energy storage systems including battery packs which may have different energy storage chemistries.

Electric vehicles such as pure electric vehicles and/or plug-in hybrid electric vehicles include direct current (DC)-DC power converters for powering a load.

### SUMMARY

An example energy storage system for an electric vehicle includes a first battery pack configured to supply power to a direct current (DC) load, the first battery pack having a first energy storage chemistry, a second battery pack configured to supply power to a DC load, the second battery pack having a second energy storage chemistry, the first battery pack electrically coupled with the second battery pack, and a charging circuit electrically coupled with the first battery pack and the second battery pack. The charging circuit includes multiple switches and a DC-DC controller configured to obtain a current temperature of the first battery pack and the second battery pack, in response to the current temperature being below a low temperature threshold value, operate the multiple switches in an alternating current (AC) heating mode to transfer energy back and forth between the first battery pack and the second battery pack at a specified frequency to increase a temperature of at least one of the first battery pack or the second battery pack, and in response to the current temperature being above a high temperature threshold value, operate the multiple switches in an energy movement mode to transfer energy from the first battery pack to the second battery pack or from the second battery pack to the first battery pack to modify a state of charge (SOC) value of at least one of the first battery pack or the second battery pack.

In some examples, the first energy storage chemistry of the first battery pack includes a sodium energy storage chemistry, and the second energy storage chemistry is different than the first energy storage chemistry.

In some examples, the second energy storage chemistry of the second battery pack includes a nickel cobalt manganese (NCM) energy storage chemistry.

In some examples, the multiple switches include a first set of three switches coupled with the first battery pack and a second set of three switches coupled with the second battery pack, and the DC-DC controller is configured to supply pulse-width modulation (PWM) signals to each of the multiple switches to control operation of the charging circuit.

In some examples, the DC-DC controller is configured to supply the PWM signals to operate at least one of the first set of three switches or the second set of three switches in a same phase, during the AC heating mode.

In some examples, the DC-DC controller is configured to supply the PWM signals to operate at least one of the first set of three switches or the second set of three switches with interleaved phases, during the energy movement mode.

In some examples, the multiple switches include a first set of three switches coupled with the first battery pack, and the DC-DC controller is configured to selectively supply pulse-width modulation (PWM) signals to each of the multiple switches to operate the charging circuit to supply energy unidirectionally from the first battery pack to the second battery pack.

In some examples, the multiple switches include a first set of three switches coupled with the second battery pack, and the DC-DC controller is configured to selectively supply pulse-width modulation (PWM) signals to each of the multiple switches to operate the charging circuit to supply energy unidirectionally from the second battery pack to first battery pack, and to selectively operate the charging circuit to supply energy unidirectionally from the second battery pack to the first battery pack.

In some examples, in response to the current temperature being above the low temperature threshold value and below the high temperature threshold value, the DC-DC controller is configured to selectively operate the multiple switches in the AC heating mode and selectively operate the multiple switches in the energy movement mode during a same time period.

In some examples, the DC-DC controller is configured to continue operating the multiple switches in the AC heating mode until the current temperature of at least one of the first battery pack and the second battery pack reaches a specified target temperature of the AC heating mode, and the DC-DC controller is configured to continue operating the multiple switches in energy movement mode until a current SOC value of at least one of the first battery pack or the second battery pack reaches a specified target SOC value of the energy movement mode.

In some examples, the DC-DC controller is configured to continue operating the multiple switches in a combined AC heating and energy movement mode until a current SOC value of at least one of the first battery pack or the second battery pack reaches a specified target SOC value and the current temperature of at least one of the first battery pack and the second battery pack reaches a specified target temperature.

In some examples, the low temperature threshold value is less than or equal to negative twenty degrees Celsius, and the high temperature threshold value is greater than or equal to zero degrees Celsius.

In some examples, at least one additional battery pack electrically coupled with the first battery pack and each having the first energy storage chemistry, and at least one additional battery pack electrically coupled with the second battery pack and each having the second energy storage chemistry.

In some examples, the energy storage system includes a first capacitor and a first switch coupled with the first battery pack, wherein the first switch is configured to bypass the first capacitor to increase a heating rate of the first battery pack when the first switch is open, and a second capacitor and a second switch coupled with the second battery pack, wherein the second switch is configured to bypass the second capacitor to increase a heating rate of the second battery pack when the second switch is open.

An example method for controlling an energy storage system for an electric vehicle, the energy storage system including a first battery pack configured to supply power to a direct current (DC) load, a second battery pack configured to supply power to a DC load, and a charging circuit electrically coupled with the first battery pack and the second battery pack, wherein the first battery pack has a first energy storage chemistry, the second battery pack has a second energy storage chemistry different from the first energy storage chemistry, the first battery pack is electrically coupled with the second battery pack, and the charging circuit includes multiple switches and a DC-DC controller, the method comprising obtaining a current temperature of the first battery pack and the second battery pack, in response to the current temperature being below a low temperature threshold value, operating the multiple switches in an alternating current (AC) heating mode to transfer energy back and forth between the first battery pack and the second battery pack at a specified frequency to increase a temperature of at least one of the first battery pack or the second battery pack, and in response to the current temperature being above a high temperature threshold value, operating the multiple switches in an energy movement mode to transfer energy from the first battery pack to the second battery pack or from the second battery pack to the first battery pack to modify a state of charge (SOC) value of at least one of the first battery pack or the second battery pack. For example, the AC heating mode and the energy movement mode may operate simultaneously.

In some examples, the first energy storage chemistry of the first battery pack includes a sodium energy storage chemistry.

In some examples, the second energy storage chemistry of the second battery pack includes a nickel cobalt manganese (NCM) energy storage chemistry.

In some examples, the multiple switches include a first set of three switches coupled with the first battery pack and a second set of three switches coupled with the second battery pack, and the method includes supplying pulse-width modulation (PWM) signals to each of the multiple switches to control operation of the charging circuit.

In some examples, supplying the PWM signals includes supplying the PWM signals to operate at least one of the first set of three switches or the second set of three switches in a same phase, during the AC heating mode.

In some examples, supplying the PWM signals includes supplying the PWM signals to operate at least one of the first set of three or the second set of three switches with interleaved phases, during the energy movement mode.

In some examples, the multiple switches include a first set of three switches coupled with the first battery pack, and the method includes supplying pulse-width modulation (PWM) signals to each of the multiple switches to selectively operate the charging circuit to supply energy unidirectionally from the first battery pack to the second battery pack, and to selectively operate the charging circuit to supply energy unidirectionally from the second battery pack to the first battery pack.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle including a rechargeable energy storage system (RESS) including, according to an example of the present disclosure;

FIG. 2A is an example circuit diagram of a direct current (DC)-DC controller for controlling power between two battery packs having different energy storage chemistries, according to an example of the present disclosure;

FIG. 2B is an example circuit diagram of a direct current (DC)-DC controller including switches for selectively coupling capacitors, according to an example of the present disclosure;

FIG. 3 is a flowchart of an example process for controlling power between two battery packs having different energy storage chemistries, according to an example of the present disclosure;

FIG. 4 is a flowchart of an example process for controlling operation of switches in alternating (AC) heating mode of the process of FIG. 3, according to an example of the present disclosure;

FIG. 5 is a flowchart of an example process for controlling operation of switches in an AC heating mode combined with energy movement mode, according to an example of the present disclosure;

FIG. 6 is a flowchart of an example process for controlling operation of switches in an energy movement mode of the process of FIG. 3, according to an example of the present disclosure;

FIG. 7 is a graph of pulse-width-modulation (PWM) signals over time operating in a same phase, according to an example of the present disclosure;

FIG. 8 is a graph of PWM signals over time operating in interleaved phases, according to an example of the present disclosure;

FIG. 9 is a circuit diagram of unidirectional transfer of energy from a sodium battery pack to a nickel cobalt manganese (NCM) battery pack, according to an example of the present disclosure; and

FIG. 10 is a circuit diagram of unidirectional transfer of energy from a nickel cobalt manganese (NCM) battery pack to a sodium battery pack, according to an example of the present disclosure.

In the drawings, reference numbers may be reused to identify similar and/or identical elements.

### DETAILED DESCRIPTION

In some example embodiments, an energy storage system for a vehicle includes a direct current (DC)-DC circuit architecture for supplying power from battery packs, which may optionally have different energy storage chemistries such as a first set of sodium-ion battery packs coupled in series with one another, electrically coupled (e.g., in series) with a second set of nickel cobalt manganese (NCM) battery packs coupled in series with one another. Example control strategies are described herein to realize different operation modes with improved performance.

For example, during an active heating mode, switches of a charging circuit may be controlled to realize alternating charging and discharging between two packs having different chemistries, such as pendulum-type energy transfer back and forth between the two packs at a high frequency to provide maximum heating power of the two packs. During a dynamic energy distribution mode, switches may be controlled to improve efficiency by reducing current ripple (such as by using interleaved pulse-width-modulation (PWM) signals, etc.).

In some examples, a set of three switches is coupled with each battery pack, and a DC-DC controller is configured to control energy exchange between an NCM battery pack and a sodium battery pack (or other suitable energy storage chemistries), at a high frequency to operate in an alternating current (AC) heating mode to quickly raise a temperature of the battery packs. This may occur, for example, when a sensed temperature of the battery backs is below a low temperature threshold. The low temperature threshold may be indicative that the battery packs need to be warmed for proper or desired operation, such as a temperature of negative twenty degrees Celsius or below.

In some examples, the DC-DC controller may be configured to transfer energy from one battery pack to another in an energy movement mode, such as when a temperature of the battery packs is above a high temperature threshold. The high temperature threshold may be indicative that the temperature of the battery packs is sufficient for desired operation, such as zero degrees Celsius or above, for example.

The DC-DC controller may be configured to operate switches coupled with a sodium battery pack using PWM signals, while opening switches coupled with an NCM battery pack, to move energy from the sodium battery pack to the NCM battery pack. Similarly, the DC-DC controller may be configured to operate switches coupled with the NCM battery pack using PWM signals, while opening switches coupled with a sodium battery pack, to move energy from the NCM battery pack to the sodium battery pack.

In some examples, the DC-DC controller may be configured to operate in a combination mode of AC heating and energy movement, using PWM and duty cycle control. For example, the DC-DC controller may be configured to selectively operate the switches to transfer power back and forth at a high frequency to warm the batteries in an AC heating mode, and selectively operate the switches to transfer power form one battery pack to another to balance or adjust state of charge (SOC) values of the battery packs in an energy movement mode. The combined AC heating and energy movement mode may occur while the temperature of the battery packs is between the high and low temperature threshold values associated with the AC heating and energy movement modes.

Although some examples are described with reference to sodium battery packs and NCM battery packs, other suitable energy storage chemistries may be used in other example embodiments. Each battery pack may include one or more battery packs electrically coupled with one another (e.g., in series or in parallel), which may define all or a portion of a battery module of a vehicle (e.g., in a rechargeable energy storage system (RESS) of the vehicle).

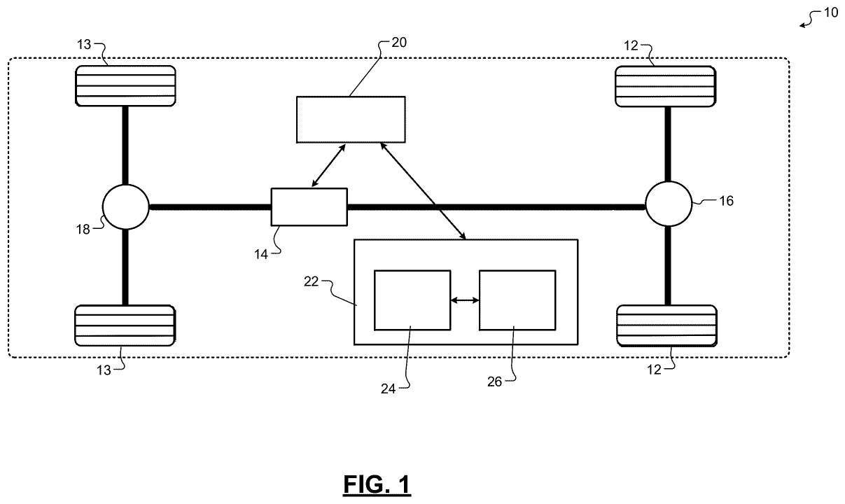

Referring now to FIG. 1, a vehicle 10 includes front wheels 12 and rear wheels 13. In FIG. 1, a drive unit 14 selectively outputs torque to the front wheels 12 and/or the rear wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

While the vehicle 10 includes one drive unit 14 in FIG. 1, the vehicle 10 may have other configurations. For example, two separate drive units may drive the front wheels 12 and the rear wheels 13, one or more individual drive units may drive individual wheels, etc. As can be appreciated, other vehicle configurations and/or drive units can be used.

The vehicle control module 20 may be configured to control the operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel, an acceleration paddle, etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, including one or more vehicle sensors (such as cameras, microphones, pressure sensors, wheel position sensors, location sensors such as global positioning system (GPS) antennas, etc.).

Some sensors may be configured to monitor current motion of the vehicle, acceleration of the vehicle, steering torque, etc.

As shown in FIG. 1, the vehicle 10 includes a vehicle battery module 22, which may include any suitable batteries for supplying power to the vehicle 10. For example, the vehicle battery module 22 may include one or more batteries, battery packs, etc., which can be recharged and store power to supply energy to the vehicle (such as lithium batteries). The batteries, battery packs, etc., may be connected with one another in any suitable arrangement, such as multiple groups in parallel, in series, etc. The vehicle battery module 22 may be considered as, or part of, a rechargeable energy storage system (RESS).

The vehicle battery module 22 may supply power to one or more components of the vehicle 10, such as the drive unit 14, the vehicle control module 20, other electronic components of the vehicle 10, etc. The vehicle control module 20 may be coupled to control charging and discharging of the vehicle battery module 22.

As shown in FIG. 1, the vehicle battery module 22 may be a mixed chemistry battery module including a first chemistry battery pack 24, and a second chemistry battery pack 26. For example, the first chemistry battery pack 24 may include one or more battery packs (e.g., coupled together in series or in parallel), which have a first energy storage chemistry such as sodium.

The second chemistry battery pack 26 may include one or more battery packs (e.g., coupled together in series or in parallel), which have a second energy storage chemistry such as nickel cobalt manganese (NCM). The first chemistry battery pack 24 and the second chemistry battery pack 26 may be coupled in series. Each battery pack may be configured to supply power to a DC load, such as a DC bus of the vehicle 10.

One or more DC-DC controllers may be coupled to control operation of the battery module 22, such as by controlling switches of a charging circuit coupled to the first chemistry battery pack 24 and the second chemistry battery pack 26 using PWM signals. As described further below, the DC-DC controller(s) may be configured to operate the switches in different operation modes, based on temperatures of the first chemistry battery pack 24 and the second chemistry battery pack 26, such as an AC heating mode that transfers energy between the two packs back and forth at a high frequency (such as at least 500 Hertz, at least 50 kHz, etc.) to warm the battery packs, or an energy movement mode that selectively transfers energy from one battery pack to another to control SOC values for each battery pack.

Although FIG. 1 illustrates one vehicle battery module 22 having one first chemistry battery pack 24 and one second chemistry battery pack 26, other example embodiments may have more vehicle battery modules, more battery packs of either chemistry (or third or additional chemistries), vehicle battery modules and battery packs at other locations in the vehicle, etc.

The vehicle control module 20 may communicate with another device via a wireless communication interface, which may include one or more wireless antennas for transmitting and/or receiving wireless communication signals. For example, the wireless communication interface may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface may communicate with a remote computing device over one or more wireless and/or wired networks. Regarding the vehicle-to-vehicle (V2X) communication, the vehicle 10 may include one or more V2X transceivers (e.g., V2X signal transmission and/or reception antennas).

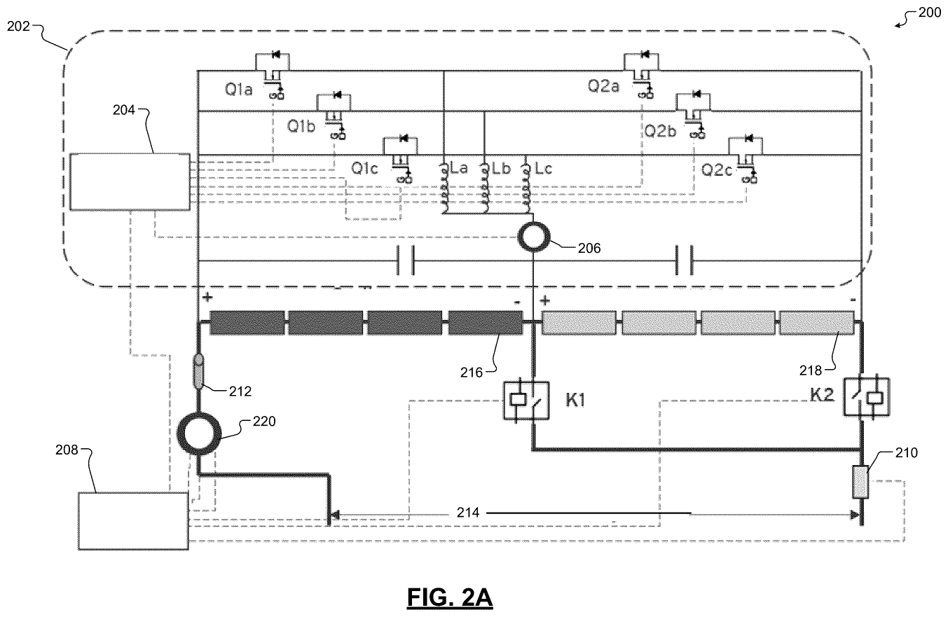

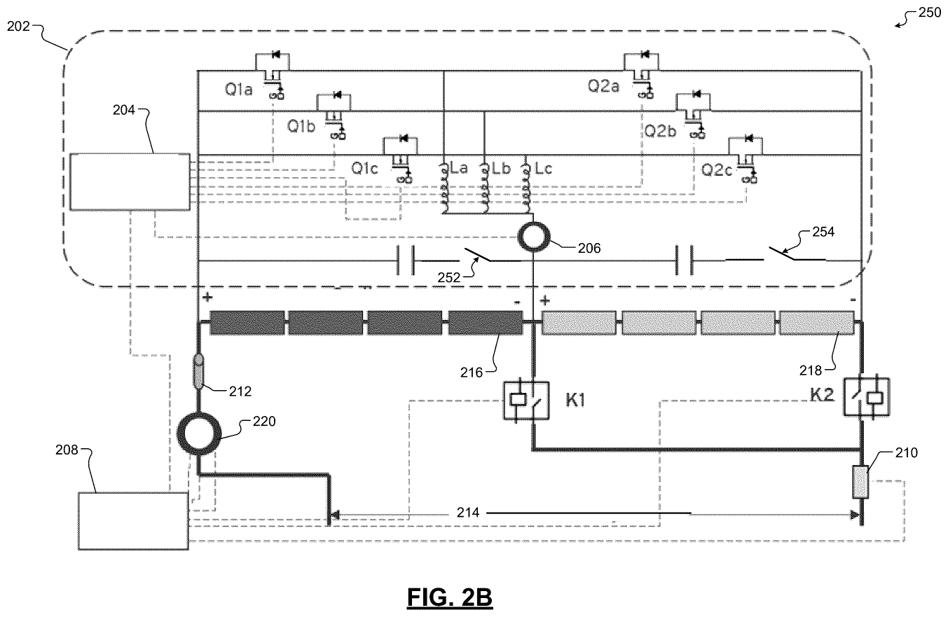

Referring now to FIG. 2A, an example battery module 200 of a vehicle energy storage system includes a charging circuit 202 including a DC-DC controller 204 and multiple switches. As shown in the example of FIG. 2A, a first set of switches Q1a, Q1b, and Q1c are electrically coupled with multiple sodium battery packs 216, and a second set of switches Q2a, Q2b and Q2c are electrically coupled with multiple NCM battery packs 218.

The multiple sodium battery packs 216 are coupled in series with the multiple NCM battery packs 218, to provide power to a DC load 214 and/or receive power from a DC charger. Three inductors La, Lb, and Lc are coupled between the multiple switches and the multiple sodium battery packs 216 and NCM battery packs 218. The multiple sodium battery packs 216 are coupled in parallel with a first capacitor, and the multiple NCM battery packs 218 are coupled in parallel with a second capacitor.

As shown in FIG. 2A, a current sensor 206 is coupled to sense current flowing between the multiple switches and the multiple sodium battery packs 216 and NCM battery packs 218, and a current sensor 220 is coupled to sense current between the DC load 214 and the multiple sodium battery packs 216 and NCM battery packs 218. The battery module may include other suitable circuit elements, such as a shunt 210 (e.g., a current sensor configured to sense a current between the DC load 214 and the battery pack), a fuse 212, and switches K1 and K2 which control supply of power from the multiple sodium battery packs 216 and NCM battery packs 218 to the DC load 214.

A battery management system 208 is configured to receive sensed parameters of the battery module 200, such as voltage values of the multiple sodium battery packs 216, multiple NCM battery packs 218, and the DC load 214, and current values from the current sensors 206, 210 and 220. The battery management system 208 is in communication with the DC-DC controller 204, for controlling operation of the switches based on parameters of the battery module 200.

For example, the DC-DC controller 204 may be configured to operate in an AC heating mode when sensed temperatures of the multiple sodium battery packs 216 or NCM battery packs 218 are below a low temperature threshold (e.g., less than or equal to negative twenty degrees Celsius), by using a combination of PWM signals to the switches Q1a, Q1b, Q1c, Q2a, Q2b, and Q2c to exchange energy between the multiple sodium battery packs 216 and NCM battery packs 218 at a high frequency. In this example, two or more of the switches Q1a, Q1b, Q1c, Q2a, Q2b, and Q2c may receive PWM signals having a same phase, to increase or maximize heating performance.

In another example, DC-DC controller 204 may be configured to operate in an energy movement mode when sensed temperatures of the multiple sodium battery packs 216 or NCM battery packs 218 are above a high temperature threshold (e.g., greater than or equal to zero degrees Celsius), tor transfer energy between the multiple sodium battery packs 216 and NCM battery packs 218 to adjust state of charge values for each pack.

For example, the DC-DC controller 204 may be configured to close the switches Q1a, Q1b and Q1c, with a longer on time, while opening the switches Q2a, Q2b and Q2c, to move stored energy from the multiple sodium battery packs 216 to the multiple NCM battery packs 218. For example, if the switches Q1a, Q1b, and Q1c are on (e.g., conducting), the switches Q2a, Q2b, and Q2c may be off (e.g., not conducting). This on and off operation may occur during a period of a PWM signal.

Similarly, the DC-DC controller 204 may be configured to close the switches Q2a, Q2b and Q2c, for a longer on time, while opening the switches Q1a, Q1b and Q1c, to move stored energy from the multiple NCM battery packs 218 to the multiple sodium battery packs 216. The DC-DC controller 204 may use interleaved PWM signals to the switches in the energy movement mode of operation, to reduce or minimize current ripple and loss.

In some examples, the DC-DC controller 204 may be configured to operate in a combination mode of AC heating and energy movement, using PWM and duty cycle control. This may occur, for example, when temperatures of the multiple sodium battery packs 216 and the multiple NCM battery packs 218 are between the low temperature and high temperature threshold values for individual AC heating and individual energy movement modes (e.g., between zero degrees Celsius and negative twenty degrees Celsius). For example, the DC-DC controller 204 may operate the switches to selectively transfer power between the multiple sodium battery packs 216 and the multiple NCM battery packs 218 at a high frequency to warm the battery packs, and operate the switches to selectively transfer energy between the battery packs to modify SOC values.

In some examples, the AC heating mode of operation and the energy movement mode of operation may be realized simultaneously, and the switches may be controlled either in a same phase or interleaved phases depending on whether there is a prioritized focus on heating the battery pack or a prioritized focus on energy movement. In some examples, different time periods may be used, such as operating the switches to selectively transfer power between the multiple sodium battery packs 216 and the multiple NCM battery packs 218 at a high frequency to warm the battery packs in a first variable time period, and operating the switches to selectively transfer energy between the battery packs to modify SOC values in a second variable time period, where lengths of each time period vary based on a priority setting of battery heating versus energy transfer.

FIG. 2B is an example circuit diagram of an example battery module 250, including switches for selectively coupling capacitors. The battery module 250 may be similar to the battery module 200 of FIG. 2A, with a first switch 252 coupled with a first capacitor (e.g., in series), and a second switch 254 coupled with a second capacitor.

As shown in FIG. 2B, the first switch 252 is configured to selectively bypass the first capacitor across the multiple sodium battery packs 216. For example, the DC-DC controller may be configured to selectively open the switch 252 to increase ripple current flowing in the multiple sodium battery packs 216, to increase or accelerate heating of the multiple sodium battery packs 216.

Similarly, the second switch 254 is configured to selectively bypass the second capacitor across the multiple NCM battery packs 218. The DC-DC controller may be configured to selectively open the switch 254 to increase ripple current flowing in the multiple NCM battery packs 218, to increase or accelerate heating of the multiple NCM battery packs 218.

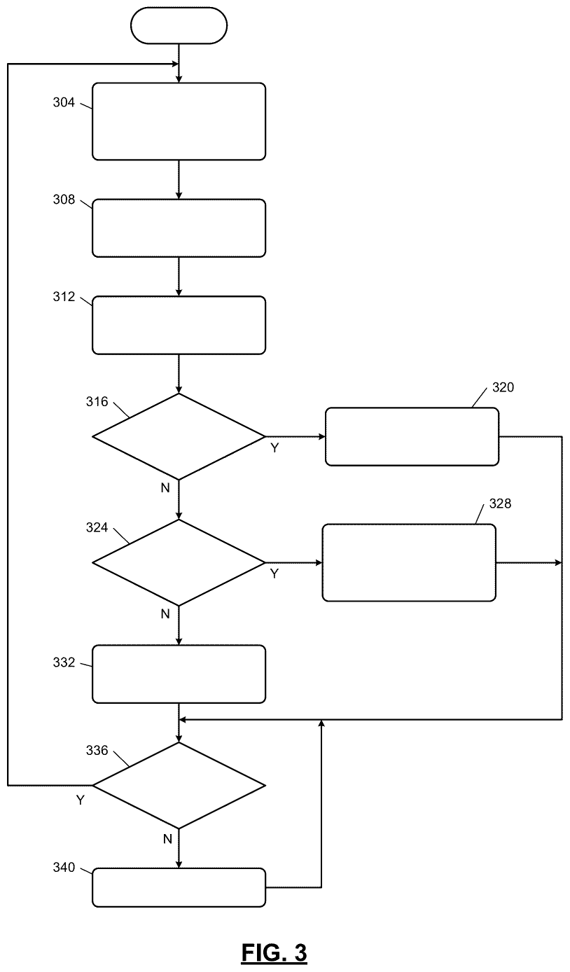

FIG. 3 is a flowchart of an example process for controlling power between two battery packs having different energy storage chemistries. The process of FIG. 3 may be implemented by, for example, the vehicle control module 20 of FIG. 1, or the DC-DC controller 204 of FIG. 2A. At 304, the process begins by obtaining state of charge (SOC), voltage, current, and temperate parameters of a battery modules (which may include temperatures of battery packs having different energy storage chemistries such as sodium and NCM).

At 308, control initializes battery module control by opening switches of the charging circuit, such as switches Q1a through Q2c of FIG. 2A. At 312, control compares a senses temperature values of the battery packs to control threshold ranges.

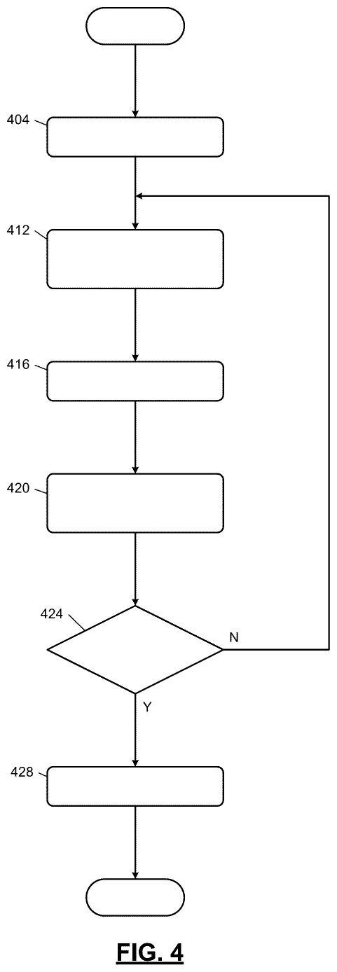

If control determines that the sensed temperature of the battery packs is less than a low temperature threshold at 316, such as below negative twenty degrees Celsius, control proceeds to 320 to operate the switches in an AC heating mode to warm the batteries. Further details of the AC heating mode are described below with reference to FIG. 4.

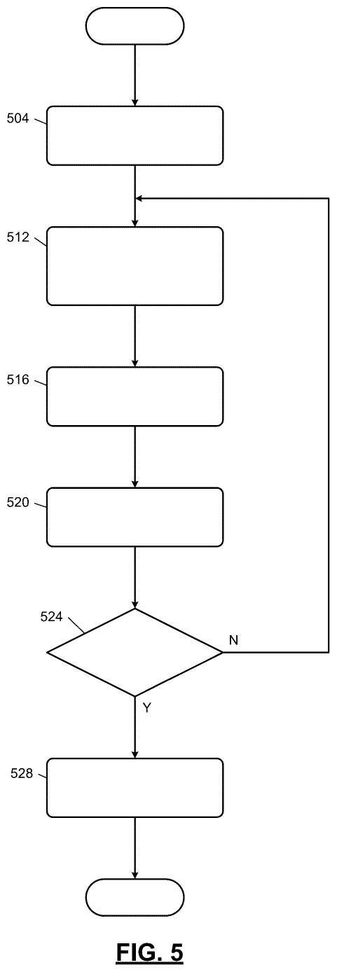

If control determines at 316 that the battery pack temperatures are above the low temperature threshold, control proceeds to 324 to determine whether the battery pack temperatures are below a high temperature threshold, such as about zero degrees Celsius. If so, control proceeds to 328 to operate the battery module in a combined AC heating with energy movement mode at 328. Further details regarding the combined AC heating with energy movement mode are described further below with reference to FIG. 5.

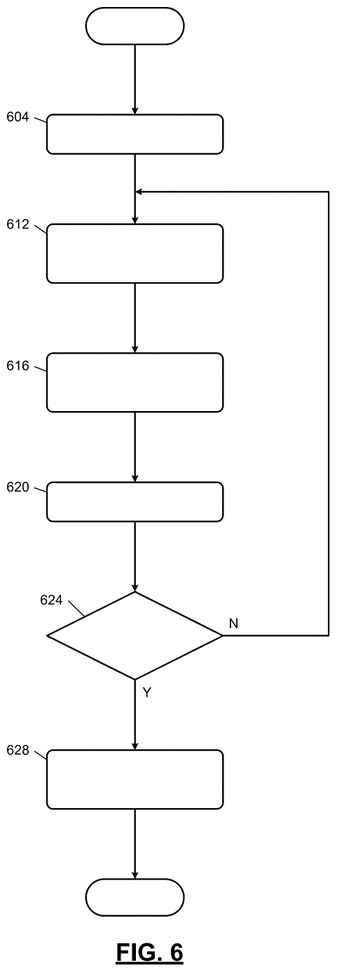

If control determines at 324 that the battery pack temperatures are above the high temperature threshold, control proceeds to 332 to operate the battery module in an energy movement mode to transfer stored energy from one battery pack chemistry to another, to adjust SOC values of the battery packs. Further details of the energy movement mode are described below with reference to FIG. 6.

At 336, control determines whether a current operating mode target has been reached, such as increasing a temperature of the battery packs to a target temperature in the AC heating mode, or increasing a SOC value for at least one of the battery packs to a target SOC value in the energy movement mode. If the target condition has not yet been reached at 336, control continues operating in the current mode at 340.

FIG. 4 is a flowchart of an example process for controlling operation of switches in an AC heating mode of the process of FIG. 3. At 404, the process begins by obtaining a target control temperature. For example, if the AC heating mode is implemented when the battery pack temperatures are below a low temperature threshold such as negative twenty degrees Celsius, control may set the target temperature as increasing the battery pack temperatures above negative twenty degrees Celsius, or increasing the battery pack temperatures to a higher target threshold value such as negative ten degrees Celsius.

At 412, control obtains voltages of the battery packs for duty cycle control. The DC-DC controller may then control two or more of the switches to operate in the same phase at 416. For example, at least two pairs of the switches Q1a-Q2c of FIG. 2A may be operated in a same phase (such as Q1a working together with Q2a, Q1b working together with Q2b, etc.), to transfer power back and forth between the first battery pack and the second battery pack at a high frequency, to quickly warm the batteries. This may result in a high or maximum heating speed, such as raising the temperature of the battery packs at least one degree Celsius per minute, at least 1.9 degrees Celsius per minute, or greater.

At 420, control obtains a current temperature of the battery packs. Control then compares the current temperature to the target temperature of the AC heating mode at 424. If the target temperature has not yet been reached at 424, control returns to 412 to continue heating the battery packs using PWM signals. Once the target temperature has been reached at 424, control ends the AC heating mode of operation at 428.

FIG. 5 is a flowchart of an example process for controlling operation of switches in a combined AC heating and energy movement mode of the process of FIG. 3. At 504, the process begins by obtaining a target state of charge value and target temperature value, for the battery packs.

At 512, control obtains voltages and temperatures of the battery packs for duty cycle control. The DC-DC controller may then control two or more of the switches Q1a-Q2c to operate in a same phase for AC heating operation, and interleaved phases for energy transfer operation, at 516. For example, control may selectively provide heating power to warm the battery packs using a first PWM signal (e.g., having a same phase for multiple switches), and selectively transfer power between the battery packs using a second PWM signal (e.g., using an interleaved signal for multiple switches). In some examples, the AC heating mode of operation and the energy movement mode of operation may be realized simultaneously, and the switches may be controlled either in a same phase or interleaved phases depending on whether there is a prioritized focus on heating the battery pack or a prioritized focus on energy movement. In some examples, different time periods may be used, such as operating the switches to selectively transfer power between the multiple sodium battery packs and the multiple NCM battery packs at a high frequency to warm the battery packs in a first variable time period, and operating the switches to selectively transfer energy between the battery packs to modify SOC values in a second variable time period, where lengths of each time period vary based on a priority setting of battery heating versus energy transfer.

At 520, control obtains current temperature values and SOC values of the battery packs. Control then compares the current temperature values and SOC values to the target temperature and SOC values of the combined AC heating and energy movement mode at 524. If the target temperature and SOC value have not yet been reached at 524, control returns to 512 to continue selectively heating and transferring stored energy between the battery packs using PWM signals. Once the target temperature and SOC value have been reached at 524, control ends the energy movement mode of operation at 528.

In some examples, multiple branches of the charging circuit may be controlled in a same phase to maximize heating power, or be phase shifted in one PWM cycle to reduce current ripple and losses. Duty cycle ratios may be controlled to move energy between two battery packs based on voltage levels of different chemistries of the battery packs. The duty cycle ratio may be controlled to supply power to a load based on voltage levels of the battery packs, while undergoing heating and energy movement.

FIG. 6 is a flowchart of an example process for controlling operation of switches in an energy movement mode. At 604, the process begins by obtaining a target state of charge value, which may indicate desired levels of charging capacity for each battery pack.

At 612, control obtains voltages of the battery packs for duty cycle control. The DC-DC controller may then control two or more of the switches to operate in interleaved phases at 616. For example, at least two of the switches Q1a-Q2c of FIG. 2A may be operated in interleaved phases, to selectively transfer stored energy from one battery pack to another, to adjust (e.g., balance) SOC values for the battery packs.

At 620, control obtains current SOC values of the battery packs. Control then compares the current SOC values to the target SOC value of the energy movement mode at 624. If the target SOC value has not yet been reached at 624, control returns to 612 to continue transferring stored energy between the battery packs using PWM signals. Once the target SOC value has been reached at 624, control ends the energy movement mode of operation at 628.

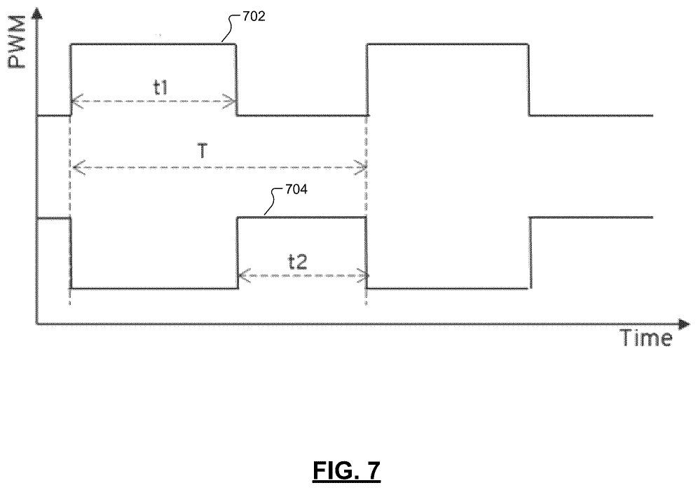

FIG. 7 is a graph of PWM signals over time operating in a same phase, according to an example the present disclosure. As shown in FIG. 7, during an AC heating mode, each of the switches Q1a, Q1b and Q1c may receive a first PWM signal 702 having a same phase (e.g., having the first on time t1). Each of the switches Q2a, Q2b and Q2c may receive a second PWM signal 704 having a same phase (e.g., having the second on time t2). This may facilitate maximum heating of the battery packs by transferring power back and forth quickly between the battery packs at a high frequency corresponding to the time period T.

In some examples, multiple branches of the circuit may be controlled in the same phase during the AC heating mode, with a larger current ripple and heating power. The current may be any suitable pattern, such as triangle waves, sine waves or square waves. Turn on and turn off durations of each switch may be controlled according to the voltage level of the two chemistries of the battery packs, to inhibit or prevent any net energy movement between the battery packs. In some examples, different operation frequencies of each branch may be tuned and optimized to reduce noise during AC heating.

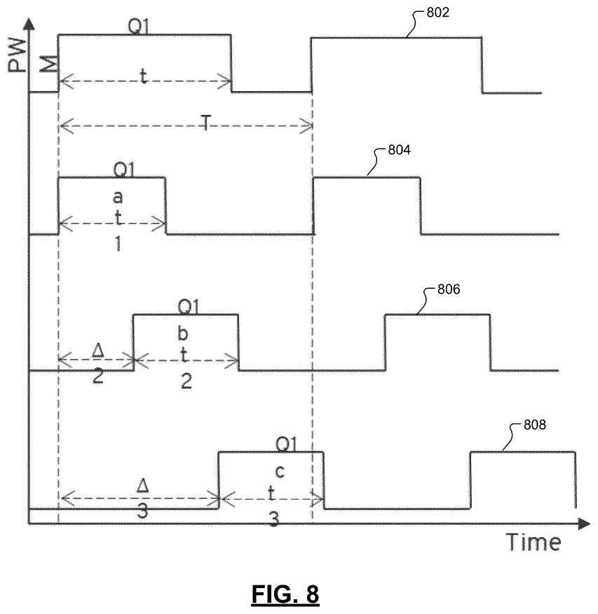

FIG. 8 is a graph of PWM signals over time operating in interleaved phases, according to an example the present disclosure. As shown in FIG. 8, during an energy movement mode, each of the switches Q1a, Q1b and Q1c may receive PWM signals having interleaved phase signals. For example, the switch Q1a may receive a first PWM signal 804 during a first on time t1, the switch Q1b may receive a second PWM signal 806 during a second on time t2 (e.g., having a start time offset by a distance delta two), and the switch Q1c may receive a third PWM signal 808 during a third on time t3 (e.g., having a start time offset by a distance delta three).

This may facilitate efficient power transfer between the battery packs with reduced current ripple or loss. FIG. 8 also illustrates an example PWM signal 802 if each switch received a signal having a same phase for an on time t. FIG. 8 also illustrates an example time period T for repeating the interleaved phases of the PWM signals.

In some examples, interleaving control may have an approximately 120 degree phase shift. In other example embodiments, duty cycle and phase shift may be controlled within one PWM control cycle to reduce the current ripple in each inductor, to improve DC-DC converter efficiency. In some examples, duty cycle may be calculated as:

$${t}_{1} = {t}_{2} = {t}_{3} = \frac{1}{\sqrt{3}} t$$

with phase delays of Δ1=0, Δ2=(⅓)*t, and Δ3=(⅔)*t. This may result in reducing a conduction loss by ⅓ compared to other interleaving control approaches.

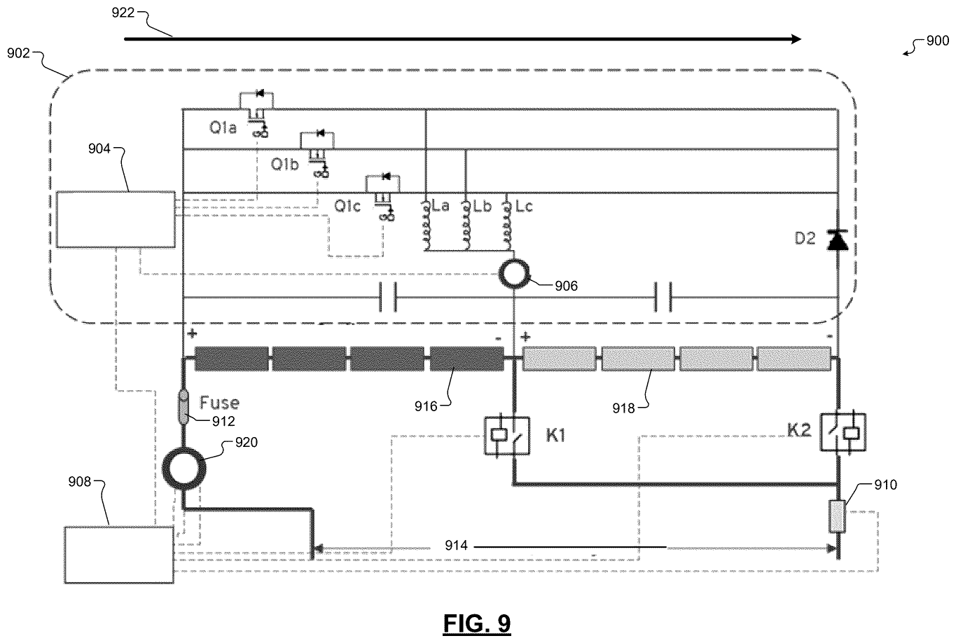

FIG. 9 is a circuit diagram of unidirectional transfer of energy from a sodium battery pack to a nickel cobalt manganese (NCM) battery pack, according to an example of the present disclosure. As shown in the example of FIG. 9, an example battery module 900 of a vehicle energy storage system includes a charging circuit 902 including a DC-DC controller 904 and multiple switches. For example, a first set of switches Q1a, Q1b and Q1c are electrically coupled with multiple sodium battery packs 916. The battery module 900 also includes multiple NCM battery packs 918.

The multiple sodium battery packs 916 are coupled in series with the multiple NCM battery packs 918, to provide power to a DC load 914 and/or receive power from a DC charger. Three inductors La, Lb and Lc are coupled between the multiple switches and the multiple sodium battery packs 916 and NCM battery packs 918. The multiple sodium battery packs 916 are coupled in parallel with a first capacitor, and the multiple NCM battery packs 918 are coupled in parallel with a second capacitor.

As shown in FIG. 9, a current sensor 906 is coupled to sense current flowing between the multiple switches and the multiple sodium battery packs 916 and NCM battery packs 918, and a current sensor 920 is coupled to sense current between the DC load 914 and the multiple sodium battery packs 916 and NCM battery packs 918. The battery module may include other suitable circuit elements, such as a shunt 910 (e.g., a current sensor configured to sense a current between the DC load 914 and the battery pack), a fuse 912, and switches K1 and K2 which control supply of power form the multiple sodium battery packs 916 and NCM battery packs 918 to the DC load 914.

A battery management system 908 is configured to receive sensed parameters of the battery module 900, such as voltage values of the multiple sodium battery packs 916, multiple NCM battery packs 918 and the DC load 914, and current values from the current sensors 906, 910 and 920. The battery management system 908 is in communication with the DC-DC controller 904, for controlling operation of the switches based on parameters of the battery module 900.

For example, the DC-DC controller 904 may be configured to provide PWM signals to the switches Q1a, Q1b and Q1c to move stored energy from the multiple sodium battery packs 916 to the multiple NCM battery packs 918. The DC-DC controller 904 may use interleaved PWM signals to the switches in the energy movement mode of operation, to reduce or minimize current ripple and loss. This may be considered as unidirectional operation, where the DC-DC controller 904 is configured to selectively transfer stored energy from the multiple sodium battery packs 916 to the multiple NCM battery packs 918.

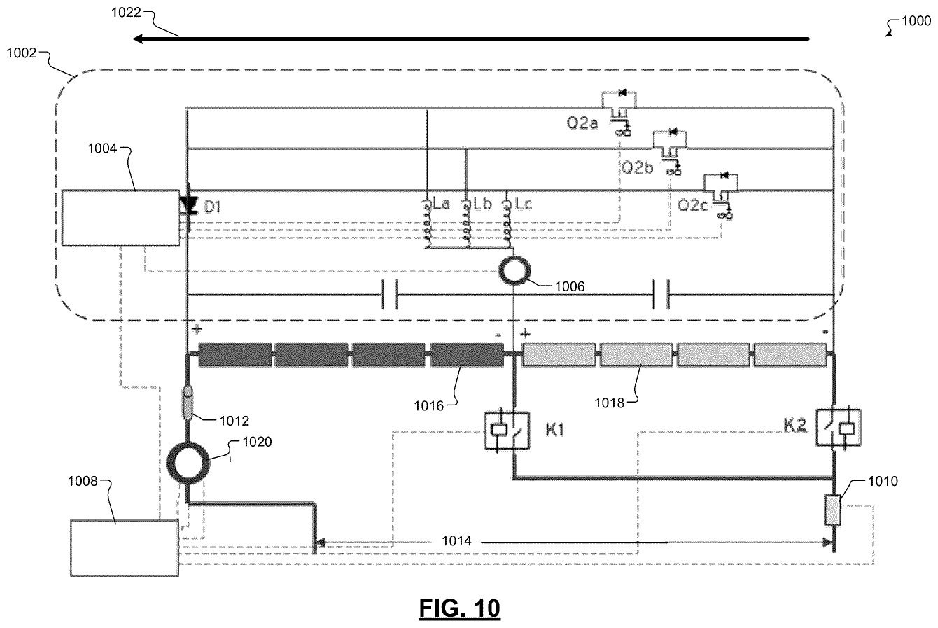

FIG. 10 is a circuit diagram of unidirectional transfer of energy from a nickel cobalt manganese (NCM) battery pack to a sodium battery pack, according to an example of the present disclosure. As shown in the example of FIG. 10, an example battery module 1000 of a vehicle energy storage system includes a charging circuit 1002 including a DC-DC controller 1004 and multiple switches. For example, a set of switches Q2a, Q2b and Q2c are electrically coupled with multiple NCM battery packs 1018. The battery module 1000 also includes multiple sodium battery packs 1016.

The multiple sodium battery packs 1016 are coupled in series with the multiple NCM battery packs 1018, to provide power to a DC load 1014 and/or receive power from a DC charger. Three inductors La, Lb and Lc are coupled between the multiple switches and the multiple sodium battery packs 1016 and NCM battery packs 1018. The multiple sodium battery packs 1016 are coupled in parallel with a first capacitor, and the multiple NCM battery packs 1018 are coupled in parallel with a second capacitor.

As shown in FIG. 10, a current sensor 1006 is coupled to sense current flowing between the multiple switches and the multiple sodium battery packs 1016 and NCM battery packs 1018, and a current sensor 1020 is coupled to sense current between the DC load 1014 and the multiple sodium battery packs 1016 and NCM battery packs 1018. The battery module may include other suitable circuit elements, such as a shunt 1010 ((e.g., a current sensor configured to sense a current between the DC load 1014 and the battery pack), a fuse 1012, and switches K1 and K2 which control supply of power form the multiple sodium battery packs 1016 and NCM battery packs 1018 to the DC load 1014.

A battery management system 1008 is configured to receive sensed parameters of the battery module 1000, such as voltage values of the multiple sodium battery packs 1016, multiple NCM battery packs 1018 and the DC load 1014, and current values from the current sensors 1006, 1010 and 1020. The battery management system 1008 is in communication with the DC-DC controller 1004, for controlling operation of the switches based on parameters of the battery module 1000.

For example, the DC-DC controller 904 may be configured to provide PWM signals to the switches Q2a, Q2b and Q2c to move stored energy from the multiple NCM battery packs 1018 to the multiple sodium battery packs 1016. The DC-DC controller 1004 may use interleaved PWM signals to the switches in the energy movement mode of operation, to reduce or minimize current ripple and loss. This may be considered as unidirectional operation, where the DC-DC controller 1004 is configured to selectively transfer stored energy from the multiple NCM battery packs 1018 to the multiple sodium battery packs 1016.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An energy storage system for an electric vehicle, the energy storage system comprising:
a first battery pack configured to supply power to a direct current (DC) load, the first battery pack having a first energy storage chemistry;
a second battery pack configured to supply power to a DC load, the second battery pack having a second energy storage chemistry, the first battery pack electrically coupled in series with the second battery pack; and
a charging circuit electrically coupled with the first battery pack and the second battery pack, wherein the charging circuit includes multiple switches and a DC-DC controller configured to:
obtain a current temperature of the first battery pack and the second battery pack;
in response to the current temperature being below a low temperature threshold value, operate the multiple switches in an alternating current (AC) heating mode to transfer energy back and forth between the first battery pack and the second battery pack at a specified frequency to increase a temperature of at least one of the first battery pack or the second battery pack; and
in response to the current temperature being above a high temperature threshold value, operate the multiple switches in an energy movement mode to transfer energy from the first battery pack to the second battery pack or from the second battery pack to the first battery pack to modify a state of charge (SOC) value of at least one of the first battery pack or the second battery pack.

2. The energy storage system of claim 1, wherein:
the first energy storage chemistry of the first battery pack includes a sodium energy storage chemistry; and
the second energy storage chemistry is different from the first energy storage chemistry.

3. The energy storage system of claim 1, wherein the second energy storage chemistry of the second battery pack includes a nickel cobalt manganese (NCM) energy storage chemistry.

4. The energy storage system of claim 1, wherein:
the multiple switches include a first set of three switches coupled with the first battery pack and a second set of three switches coupled with the second battery pack; and
the DC-DC controller is configured to supply pulse-width-modulation (PWM) signals to each of the multiple switches to control operation of the charging circuit.

5. The energy storage system of claim 4, wherein the DC-DC controller is configured to supply the PWM signals to operate at least one of the first set of three switches or the second set of three switches in a same phase, during the AC heating mode.

6. The energy storage system of claim 4, wherein the DC-DC controller is configured to supply the PWM signals to operate at least one of the first set of three switches or the second set of three switches with interleaved phases, during the energy movement mode.

7. The energy storage system of claim 1, wherein:
the multiple switches include a first set of three switches coupled with the first battery pack; and
the DC-DC controller is configured to selectively supply pulse-width-modulation (PWM) signals to each of the multiple switches to operate the charging circuit to supply energy unidirectionally from the first battery pack to the second battery pack.

8. The energy storage system of claim 7, wherein:
the multiple switches include a first set of three switches coupled with the second battery pack; and
the DC-DC controller is configured to selectively supply PWM signals to each of the multiple switches to operate the charging circuit to supply energy unidirectionally from the second battery pack to the first battery pack, and to selectively operate the charging circuit to supply energy unidirectionally from the second battery pack to the first battery pack.

9. The energy storage system of claim 1, wherein in response to the current temperature being above the low temperature threshold value and below the high temperature threshold value, the DC-DC controller is configured to selectively operate the multiple switches in the AC heating mode and selectively operate the multiple switches in the energy movement mode during a same time period.

10. The energy storage system of claim 1, wherein:
the DC-DC controller is configured to continue operating the multiple switches in the AC heating mode until the current temperature of at least one of the first battery pack and the second battery pack reaches a specified target temperature of the AC heating mode; and
the DC-DC controller is configured to continue operating the multiple switches in energy movement mode until a current SOC value of at least one of the first battery pack or the second battery pack reaches a specified target SOC value of the energy movement mode.

11. The energy storage system of claim 1, wherein the DC-DC controller is configured to continue operating the multiple switches in a combined AC heating and energy movement mode until a current SOC value of at least one of the first battery pack or the second battery pack reaches a specified target SOC value and the current temperature of at least one of the first battery pack and the second battery pack reaches a specified target temperature.

12. The energy storage system of claim 1, wherein:
the low temperature threshold value is less than or equal to negative twenty degrees Celsius; and
the high temperature threshold value is greater than or equal to zero degrees Celsius.

13. The energy storage system of claim 1, further comprising:
at least one additional battery pack electrically coupled with the first battery pack and each having the first energy storage chemistry; and
at least one additional battery pack electrically coupled with the second battery pack and each having the second energy storage chemistry.

14. The energy storage system of claim 1, further comprising:
a first capacitor and a first switch coupled with the first battery pack, wherein the first switch is configured to bypass the first capacitor to increase a heating rate of the first battery pack when the first switch is open; and
a second capacitor and a second switch coupled with the second battery pack, wherein the second switch is configured to bypass the second capacitor to increase a heating rate of the second battery pack when the second switch is open.

15. A method for controlling an energy storage system for an electric vehicle, the energy storage system including a first battery pack configured to supply power to a direct current (DC) load, a second battery pack configured to supply power to a DC load, and a charging circuit electrically coupled with the first battery pack and the second battery pack, wherein the first battery pack has a first energy storage chemistry, the second battery pack has a second energy storage chemistry different than the first energy storage chemistry, the first battery pack is electrically coupled in series with the second battery pack, and the charging circuit includes multiple switches and a DC-DC controller, the method comprising:
obtaining a current temperature of the first battery pack and the second battery pack;
in response to the current temperature being below a low temperature threshold value, operating the multiple switches in an alternating current (AC) heating mode to transfer energy back and forth between the first battery pack and the second battery pack at a specified frequency to increase a temperature of at least one of the first battery pack or the second battery pack; and
in response to the current temperature being above a high temperature threshold value, operating the multiple switches in an energy movement mode to transfer energy from the first battery pack to the second battery pack or from the second battery pack to the first battery pack to modify a state of charge (SOC) value of at least one of the first battery pack or the second battery pack.

16. The method of claim 15, wherein:
the first energy storage chemistry of the first battery pack includes a sodium energy storage chemistry; and
the second energy storage chemistry of the second battery pack includes a nickel cobalt manganese (NCM) energy storage chemistry.

17. The method of claim 15, wherein:
the multiple switches include a first set of three switches coupled with the first battery pack and a second set of three switches coupled with the second battery pack; and
the method includes supplying pulse-width-modulation (PWM) signals to each of the multiple switches to control operation of the charging circuit.

18. The method of claim 17, wherein supplying the PWM signals includes supplying the PWM signals to operate at least one of the first set of three switches or the second set of three switches in a same phase, during the AC heating mode.

19. The method of claim 17, wherein supplying the PWM signals includes supplying the PWM signals to operate at least one of the first set of three or the second set of three switches with interleaved phases, during the energy movement mode.

20. The method of claim 15, wherein:
the multiple switches include a first set of three switches coupled with the first battery pack; and
the method includes supplying pulse-width-modulation (PWM) signals to each of the multiple switches to selectively operate the charging circuit to supply energy unidirectionally from the first battery pack to the second battery pack, and to selectively operate the charging circuit to supply energy unidirectionally from the second battery pack to the first battery pack.
